(19) United States
(12) Patent Application Publication
(10) Pub. No.: US 2024/0210607 A1
(43) Pub. Date: Jun. 27, 2024

(54) PROJECTION ASSEMBLY FOR A HEAD-UP DISPLAY (HUD) WITH P-POLARIZED RADIATION

(71) Applicant: SAINT-GOBAIN GLASS FRANCE, COURBEVOIE (FR)

(72) Inventors: Jan HAGEN, BONN (DE); Pauline GIRARD, COMPIEGNE (FR)

(21) Appl. No.: 17/914,118

(22) PCT Filed: Mar. 12, 2021
(86) PCT No.: PCT/EP2021/056299

§ 371 Date: Sep. 23, 2022

(30) Foreign Application Priority Data
Apr. 16, 2020 (EP) 20169751.3

(51) Int. Cl. G02B 5/30; G02B 27/01

(52) U.S. Cl. CPC G02B 5/3066; G02B 27/0101; G02B 2207/101

(57) ABSTRACT

A projection assembly for a head-up display (HUD), includes a composite pane, including an outer pane and an inner pane that are joined to one another via a thermoplastic intermediate layer, the composite pane having an HUD region; an HUD reflection layer suitable for reflecting p-polarized radiation, on the surface of the outer pane or of the inner pane facing the intermediate layer or within the intermediate layer; an HUD projector that is directed at the HUD region and that emits p-polarized radiation; and a high-refractive-index coating having a refractive index of at least 1.7 on the surface of the inner pane facing away from the intermediate layer. The high-refractive-index coating is a sol-gel coating.

The invention relates to a projection assembly for a head-up display.

Modern automobiles are increasingly equipped with so-called head-up displays (HUDs). With a projector, typically in the region of the dashboard, images are projected onto the windshield, reflected there, and perceived by the driver as a virtual image behind the windshield (from his point of view). Thus, important data can be projected into the driver's field of vision, for example, the current driving speed, navigation or warning messages, which the driver can perceive without having to divert his glance from the road. Head-up displays can thus contribute significantly to an increase in traffic safety.

HUD projectors typically irradiate the windshield with an angle of incidence of about 65°, which results from the installation angle of the windshield and the positioning of the projector in the vehicle. This angle of incidence is near Brewster's angle for an air/glass transition (roughly 56.5° for soda lime glass). Customary HUD projectors emit s-polarized radiation, which is effectively reflected by the glass surfaces at such an angle of incidence. The problem arises that the projector image is reflected on both external surfaces of the windshield. As a result, in addition to the desired primary image, a slightly offset secondary image also appears, the so-called ghost image (“ghost”). The problem is usually mitigated by arranging the surfaces at an angle relative to one another, in particular by using a wedge-like intermediate layer for the lamination of windshields implemented as a composite pane such that the primary image and the ghost image are superimposed on one another. Composite glasses with wedge films for HUDs are known, for example, from WO2009/071135A1, EP1800855B1, or EP1880243A2.

The wedge films are expensive such that production of such a composite pane for an HUD is quite cost intensive. Consequently, there is a need for HUD projection assemblies that work with windshields without wedge films. For example, it is possible to operate the HUD projector with p-polarized radiation, which is not significantly reflected by the pane surfaces. Instead, the windshield has a reflection coating as a reflection surface for the p-polarized radiation, in particular with metallic and/or dielectric layers. HUD projection assemblies of this type are known, for example, from DE102014220189A1, US2017242247A1, WO2019046157A1, WO2019179682A1, and WO2019179683A1.

However, the reflection of p-polarized radiation is completely suppressed on glass surfaces only when the angle of incidence is exactly equal to Brewster's angle. Since the typical angle of incidence of approx. 65° is close to the Brewster's angle but deviates significantly from it, a certain residual reflection of the projector radiation from the glass surfaces results. While the reflection from the exterior-side surface of the outer pane is attenuated as result of the radiation reflection at the reflection coating, the reflection can appear, in particular, at the interior-side surface of the inner pane as a weak but nevertheless distracting ghost image. In addition, the angle of incidence of 65° refers to only one point on the windshield. However, since the HUD projector irradiates a larger HUD region on the windshield, larger angles of incidence of, for example, up to 68° or even up to 72° can occur locally. Since, there, the deviation from Brewster's angle is even more pronounced, the ghost image appears with even greater intensity. In addition, there is an observable trend among auto manufacturers to install windshields shallower. This increases the angle of incidence and, thus, the deviation from Brewster's angle as well.

WO2019179682A1, WO2019179683A1, WO2019206493A1, and US20190064516A1 disclose windshields for HUD projection assemblies that are provided on the interior-side surface with an anti-reflection coating in order to reduce the reflectivity of the interior-side surface.

EP0844507A1 discloses another HUD projection assembly, wherein a windshield is irradiated with p-polarized radiation. In order to adapt Brewster's angle to the angle of incidence and thus to avoid residual reflection on the surface of the pane, an optically high-refractive-index coating is applied (“Brewster's angle regulating film”) is applied on the interior-side surface of the inner pane. The coating is made of titanium oxide and sputtered onto the surface of the pane.

The object of the present invention is to provide an improved HUD projection assembly, wherein the HUD image is generated by reflection of p-polarized radiation from a reflection coating and wherein interfering residual reflections from the glass surfaces are reduced.

The object of the present invention is accomplished according to the invention by a projection assembly in accordance with claim 1. Preferred embodiments are disclosed in the dependent claims.

In order to make the ghost image caused by the slight reflection of the p-polarized radiation from the glass surfaces, in particular from the interior-side surface of the inner pane, less distracting, it is necessary to increase the contrast between the desired and the undesired reflection. The ratio of the reflection from the reflection coating to the reflection from the interior-side surface must thus be shifted in favor of the former reflection. Intuitively, it seems obvious, for this purpose, to apply an anti-reflection coating on the interior-side surface in order to reduce reflection from this interior-side surface. Instead, the present invention is based on an optically high-refractive-index coating on the interior-side surface of the inner pane, which is actually suitable for increasing the overall reflection. Consequently, it is also referred to as a reflection-enhancing coating. Although the overall reflectivity of the interior-side surface is increased, with the p-polarized radiation, the ghost image appears less pronounced relative to the desired primary image. For the person skilled in the art, this is initially unexpected and surprising.

According to an explanation by the inventors, the effect is based on the increase in the refractive index of the interior-side surface as a result of the high-refractive-index coating. This increases the Brewster's angle α_{Brewster} at the interface, since this is known to be determined as

$${α}_{Brewster} = arctan ( \frac{{n}_{2}}{{n}_{1}} ) ,$$

where n₁ is the refractive index of air and n₂ is the refractive index of the material that the radiation strikes. The high-refractive-index coating with the high refractive index leads to an increase in the effective refractive index of the glass surface and thus to a shift of the Brewster's angle to larger values compared to an uncoated glass surface. As a result, in the customary geometric relations of HUD projection assemblies in vehicles, the difference between the angle of incidence and the Brewster's angle becomes smaller such that the reflection of the p-polarized radiation from the interior-side surface is suppressed and the ghost image generated thereby is weakened. This is the major advantage of the present invention.

The projection assembly according to the invention for a head-up display (HUD) includes a composite pane and an HUD projector. As is usual with HUDs, the projector irradiates a region of the composite pane where the radiation is reflected in the direction of the viewer generating a virtual image, which the viewer perceives, from his point of view, as behind the windshield. The region of the windshield that can be irradiated by the projector is referred to as the HUD region. The beam direction of the projector can typically be varied by mirrors, in particular vertically, in order to adapt the projection to the height of the viewer. The region in which the eyes of the viewer must be situated with a given mirror position is referred to as the “eye box window”. This eye box window can be shifted vertically by adjustment of the mirrors, with the entire area thus available (i.e., the superimposing of all possible eye box windows) referred to as the “eye box”. A viewer situated within the eye box can perceive the virtual image. This, of course, means that the eyes of the viewer must be situated within the eye box, not the entire body.

The technical terms used here from the field of HUDs are generally known to the person skilled in the art. For a detailed presentation, reference is made to Alexander Neumann's dissertation “Simulation-Based Measurement Technology for Testing Head-Up Displays” at the Institute of Computer Science at the Technical University of Munich (Munich: University Library of the Technical University of Munich, 2012), in particular Chapter 2 “The Head-Up Display”.

The composite pane according to the invention is preferably a windshield of a vehicle, in particular of a motor vehicle, for example, a passenger car or a truck. HUDs, in which the projector radiation is reflected on a windshield to generate an image perceptible to the driver (viewer), are particularly common. In principle, however, it is also conceivable to project the HUD projection onto other panes, in particular vehicle panes, for example, onto a side window or a rear window. The HUD of the side window can, for example, mark persons or other vehicles with which a collision is imminent when their position is detected by cameras or other sensors. An HUD of a rear window can provide information to the driver when backing up.

The composite pane comprises an outer pane and an inner pane that are joined to one another via a thermoplastic intermediate layer. The composite pane is intended, in a window opening of a vehicle, to separate the interior from the outside environment. In the context of the invention, the term “inner pane” refers to the pane of the composite pane facing the vehicle interior. The term “outer pane” refers to the pane facing the outside environment.

The composite pane has an upper edge and a lower edge as well as two side edges extending therebetween. “Upper edge” refers to that edge that is intended to point upward in the installed position. “Lower edge” refers to that edge that is intended to point downward in the installed position. In the case of a windshield, the upper edge is also often referred to as the “roof edge”; and the lower edge, as the “engine edge”.

The outer pane and the inner pane have in each case an exterior-side surface and an interior-side surface and a peripheral side edge extending therebetween. In the context of the invention, “exterior-side surface” refers to that primary surface that is intended, in the installed position, to face the outside environment. In the context of the invention, “interior-side surface” refers to that primary surface that is intended, in the installed position, to face the interior. The interior-side surface of the outer pane and the exterior-side surface of the inner pane face each other and are joined to one another by the thermoplastic intermediate layer.

The projector (HUD projector) is directed at the HUD region of the composite pane. The projector is arranged on the interior-side of the composite pane and irradiates the composite pane via the interior-side surface of the inner pane. The radiation of the projector is at least partially p-polarized, with the p-polarized radiation component preferably being at least 80%. The radiation of the projector is preferably completely or almost completely p-polarized (essentially purely p-polarized). The p-polarized radiation component is 100% or deviates only insignificantly therefrom. The indication of the polarization direction is based on the plane of incidence of the radiation on the composite pane. The expression “p-polarized radiation” refers to radiation whose electric field oscillates in the plane of incidence. “S-polarized radiation” refers to radiation whose electric field oscillates perpendicular to the plane of incidence. The plane of incidence is generated by the vector of incidence and the surface normal of the composite pane in the geometric center of the irradiated region.

During operation of the HUD, the p-polarized radiation emitted by the projector irradiates the HUD region for generating the HUD projection. The radiation of the projector is in the visible spectral range of the electromagnetic spectrum—typical HUD projectors operate at the wavelengths 473 nm, 550 nm, and 630 nm (RGB). Since the typical angle of incidence for HUD projection assemblies is relatively close to Brewster's angle for an air/glass transition (56.5° to 56.6°, soda lime glass, n₂=1.51-1.52), p-polarized radiation is hardly reflected by the pane surfaces. Consequently, ghost images due to reflection from the interior-side surface of the inner pane and the exterior-side surface of the outer pane occur only with low intensity. In addition to the avoidance of ghost images, the use of p-polarized radiation also has the advantage that the HUD image is recognizable for wearers of polarization-selective sunglasses, which typically allow only p-polarized radiation to pass through and block s-polarized radiation.

The angle of incidence of the projector radiation is the angle between the vector of incidence of the projector radiation and the interior-side surface normal (i.e., the surface normal on the interior-side external surface of the composite pane). With typical HUD assemblies, the angle of incidence of the projector radiation on the composite pane is approximated at 65°. In particular, this value results from the installation angle of typical windshields (65°) of passenger cars and the fact that the projector irradiates the pane precisely from below; i.e., the projector radiation is emitted substantially vertically. The geometric center of the HUD region is usually used to determine the angle of incidence. However, since it is not a single point but rather an area (namely, the HUD region) that is the irradiated and, in addition, the projector radiation can be adjusted within certain limits (via projection elements such as lenses and mirrors) such that the HUD image can be perceived by viewers of different heights, there is, in reality, a distribution of angles of incidence in the HUD region. This distribution of angles of incidence must be used as the basis for the design of the projection assembly. The angles of incidence that occur are typically from 58° to 72°, preferably from 62° to 68°. The values refer to the entire HUD region such that at no point in the HUD region is there an angle of incidence outside the ranges mentioned.

The ratio of the reflectance R₂₀ with respect to p-polarized radiation of the reflection coating to the reflectance R_{IV} with respect to p-polarized radiation of the interior-side surface of the inner pane with the reflection-enhancing coating (expressed as the reflection quotient R₂₀/R_{IV}; R₂₀ divided by R_{VI} [sic]) is preferably at least 50:1, particularly preferably at least 100:1, specifically at all angles of incidence occurring in the HUD region. The reflectance describes the portion of the total p-polarized radiation that is reflected. It is indicated as a percentage (relative to 100% incident radiation) or as a unitless number from 0 to 1 (normalized to the incident radiation). Plotted as a function of wavelength, it forms the reflection spectrum. The data concerning reflectance are based on a reflectance measurement with a light source of illuminant A that radiates uniformly in the spectral range from 380 nm to 780 nm with a normalized radiation intensity of 100%.

In order to produce an HUD image despite the low reflection at the glass surfaces, the composite pane according to the invention is equipped with a reflection layer. The reflection layer is provided for the purpose of reflecting the radiation of the projector. For this, the reflection layer is, in particular, suitable for reflecting p-polarized radiation. As a result, a virtual image is generated from the projector radiation, which image the viewer (in particular, the driver of the vehicle) can perceive from his point of view as behind the composite pane. According to the invention, the reflection layer is arranged in the interior of the composite pane. It can be arranged as a reflection coating on the interior-side surface of the outer pane facing the intermediate layer or on the exterior-side surface of the inner pane facing the intermediate layer. Alternatively, the reflection layer can be arranged within the intermediate layer, for example, as a reflection coating applied to a carrier film that is arranged between two bonding films, or as a coating-free reflective polymer film. Typical carrier films are made of PET and have a thickness of, for example, 50 μm.

The reflection layer is transparent, which means, in the context of the invention, that it has an average transmittance in the visible spectral range of at least 70%, preferably at least 80%, and thus does not substantially restrict vision through the composite pane. In principle, it is sufficient for the HUD region of the composite pane to be provided with the reflection layer. However, other areas can also be provided with the reflection layer, and the composite pane can be provided with the reflection layer substantially over its entire surface, which may be preferable for production technology reasons, in particular if the reflection layer is implemented as a reflection coating. In one embodiment of the invention, at least 80% of the pane surface is provided with the reflection coating. In particular, the reflection coating is applied to the pane surface over its entire surface with the exception of a peripheral edge region and, optionally, a local region intended to ensure the transmittance of electromagnetic radiation through the windshield as communication windows, sensor windows, or camera windows, and, consequently, are not provided with the reflection coating. The peripheral uncoated edge region has, for example, a width of up to 20 cm. It prevents direct contact of the reflection coating with the surrounding atmosphere such that the reflection coating is protected, inside the composite pane, against corrosion and damage.

The invention is not restricted to specific reflection layers, provided the reflection layer is suitable for the reflection of the projector radiation. In order for a high intensity to be produced, the reflection layer should have high reflectance with respect to p-polarized radiation, in particular in the spectral range from 450 nm to 650 nm, which is relevant for HUD displays (HUD projectors typically operate at the wavelengths 473 nm, 550 nm, and 630 nm (RGB)). The composite pane provided with the reflection layer preferably has, in the spectral range from 450 nm to 650 nm an averaged reflectance with respect to p-polarized radiation of at least 15%, particularly preferably of at least 20%. With this, a sufficiently high-intensity projection image is generated. Particularly good results are achieved when the reflectance in the entire spectral range from 450 nm to 650 nm is at least 15%, preferably at least 20%, such that the reflectance is not below the values indicated at any point in the spectral range indicated. The data are based on the reflectance measured with an angle of incidence of 65° relative to the interior-side surface normal, measured with a light source that radiates evenly in the spectral range under consideration with a normalized radiation intensity of 100%.

In order to obtain a display of the projector image that is as color-neutral as possible, the reflection spectrum should be as smooth as possible with respect to p-polarized radiation and have no pronounced local minima and maxima. In an embodiment preferred in this regard, in the spectral range from 450 nm to 650 nm, the difference between the maximally occurring reflectance and the mean of the reflectance and the difference between the minimally occurring reflectance and the mean of the reflectance should be at most 3%, particularly preferably at most 2%. The resultant difference is to be understood as the absolute deviation of reflectance (reported in %), not as a percentage deviation relative to the mean. Alternatively, as a measure of the smoothness of the reflection spectrum, the standard deviation in the spectral range of 450 nm to 650 nm can be used. It is preferably less than 1%, particularly preferably less than 0.9%, most particularly preferably less than 0.8%.

In one embodiment of the invention, the reflection layer is a reflection coating. The reflection coating is preferably a thin-film stack, i.e., a layer sequence of thin individual layers. The desired reflection characteristics are achieved in particular by the selection of the materials and the thicknesses of the individual layers. The reflection coating can thus be suitably adjusted.

In one embodiment of the invention, the reflection coating has at least one electrically conductive layer, which is primarily responsible for the reflecting effect. The electrically conductive layer can be a metal-containing layer or also a layer based on a transparent conductive oxide (TCO). The metal-containing layer can, for example, be based on silver, gold, aluminum, or copper. A common TCO is in particular indium tin oxide (ITO).

Typically, dielectric layers or layer sequences are arranged above and below the electrically conductive layer. If the reflection coating includes multiple conductive layers, each conductive layer is in each case preferably arranged between two typically dielectric layers or layer sequences such that a dielectric layer or layer sequence is arranged between adjacent conductive layers. The coating is thus a thin-film stack with n electrically conductive layers and (n+1) dielectric layers or layer sequences, where n is a natural number and wherein a lower dielectric layer or layer sequence is in each case followed alternatingly by a conductive layer and a dielectric layer or layer sequence. Such coatings are known as solar protective coatings and heatable coatings. Due to the at least one electrically conductive layer, the reflection coating has IR-reflecting properties such that it functions as a solar protection coating that reduces heating of the vehicle interior by reflection of thermal radiation. The reflection coating can also be used as a heating coating, if it is electrically contacted such that a current that heats the reflection coating flows through it.

In a preferred embodiment, the reflection coating has at least one electrically conductive layer based on silver (Ag). The conductive layer preferably contains at least 90 wt.-% silver, particularly preferably at least 99 wt.-% silver, most particularly preferably at least 99.9 wt.-% silver. The silver layer can have dopants, for example, palladium, gold, copper, or aluminum. The thickness der silver layer is usually from 5 nm to 20 nm.

Common dielectric layers of such a thin-film stack are, for example:
anti-reflection layers, which reduce the reflection of visible light and thus increase the transparency of the coated pane, for example, based on silicon nitride, mixed silicon-metal nitrides, such as silicon-zirconium nitride, titanium oxide, aluminum nitride, or tin oxide, with layer thicknesses of, for example, 10 nm to 100 nm;
matching layers, which improve the crystallinity of the electrically conductive layer, for example, based on zinc oxide (ZnO), with layer thicknesses of, for example, 3 nm to nm;
smoothing layers, which improve the surface structure for the overlying layers, for example, based on a non-crystalline oxide of tin, silicon, titanium, zirconium, hafnium, zinc, gallium, and/or indium, in particular based on mixed tin-zinc oxide (ZnSnO), with layer thicknesses of, for example, 3 nm to 20 nm.

Due to the at least one electrically conductive layer, such a coating has reflecting properties in the visible spectral range, which always occur to a certain extent with respect to p-polarized radiation. The reflection with respect to p-polarized radiation can be specifically optimized by a suitable selection of layer thicknesses, in particular of the dielectric layer sequence.

In addition to the electrically conductive layers and dielectric layers, the reflection coating can also include blocking layers, which protect the conductive layers against degeneration. Blocking layers are typically very thin metal-containing layers based on niobium, titanium, nickel, chromium, and/or alloys with layer thicknesses of, for example, 0.1 nm to 2 nm.

The reflection coating need not necessarily include electrically conductive layers. In another embodiment of the invention, the entire thin-film stack is formed from dielectric layers. The layer sequence includes, alternatingly, layers with a high refractive index and a low refractive index. The reflection behavior of such a layer sequence can be specifically adjusted by suitable selection of materials and layer thicknesses as a result of interference effects. It is thus possible to implement a reflection coating with effective reflection with respect to p-polarized radiation in the visible spectral range. The layers with a high refractive index (optically high-refractive-index layers) preferably have a refractive index greater than 1.8. The layers with a low refractive index (optically low-refractive-index layers) preferably have a refractive index less than 1.8. The uppermost and the lowermost layer of the thin-film stack are preferably optically high-refractive-index layers. The optically high-refractive-index layers are preferably based on silicon nitride, tin-zinc oxide, silicon-zirconium nitride, or titanium oxide, particularly preferably based on silicon nitride. The optically low-refractive-index layers are preferably based on silicon oxide. The total number of high- and low-refractive-index layers is preferably from 3 to 15, in particular from 8 to 15. This makes possible a suitable design of reflection properties without making the layer structure too complex. The layer thicknesses of the dielectric layers should preferably be from 30 nm to 500 nm, particularly preferably from 50 nm to 300 nm.

In another embodiment, the reflection layer according to the invention is implemented as a polymer film that does not have a reflection coating but, instead, has intrinsically reflective properties. For this purpose, the polymer film preferably includes a plurality of polymeric plies (layers) with different refractive indices, with plies with higher and lower refractive indices arranged alternatingly. In this case as well, the reflection effect is based in particular on interference effects caused by the alternating high- and low-refractive-index polymeric plies.

According to the invention, the composite pane is provided with an optically high-refractive-index coating that is arranged on the interior-side surface of the inner pane facing away from the intermediate layer. In the context of the present invention, the high-refractive-index coating is also referred to as a reflection-enhancing coating, since it typically increases the overall reflectivity of the coated surface. According to the invention, the reflection-enhancing coating has a refractive index of at least 1.7, which is the basis for the reflection-enhancing effect. Surprisingly, the reflection-enhancing coating does not cause any enhancement of the HUD ghost image from the interior-side surface of inner pane, but, instead, weakens it such that the desired reflection from the reflection coating appears with higher contrast.

The term “reflection-enhancing coating” should not be interpreted to mean that the reflection-enhancing effect is related to p-polarized radiation. The reflection-enhancing coating is not intended to increase the reflection with respect to the p-polarized radiation of the projector at the angles of incidence under consideration. Instead, due to its high refractive index, the reflection-enhancing coating causes an increase in the overall reflection in the visible spectral range, in particular at angles of incidence that deviate significantly from Brewster's angle. For a clearer conceptual distinction, the reflection coating can also be referred to as “HUD reflection coating”; and the reflection-enhancing coating, as “total-reflection-enhancing coating”.

The refractive index of the reflection-enhancing coating is preferably at least 1.8, particularly preferably at least 1.9, most particularly preferably at least 2.0. Particularly good results are achieved with this. The refractive index is preferably at most 2.5—a further increase in the refractive index would not bring any further improvement in terms of p-polarized radiation, but would increase the overall reflectivity.

In the context of the present invention, refractive indices are, in principle, specified based on a wavelength of 550 nm. Unless otherwise indicated, the indications of layer thicknesses or thicknesses refer to the geometric thickness of a layer.

The reflection-enhancing coating is preferably formed from a single layer and has no other layers below or above this layer. A single layer is sufficient to achieve the effect according to the invention and is technically simpler than applying a layer stack. In principle, however, the reflection-enhancing coating can also include multiple individual layers, which can also be desirable for optimizing specific parameters in the individual case.

Suitable materials for the reflection-enhancing coating are silicon nitride (Si₃N₄), a mixed silicon-metal nitride (for example, silicon-zirconium nitride (SiZrN), mixed silicon-aluminum nitride, mixed silicon-hafnium nitride, or mixed silicon-titanium nitride), aluminum nitride, tin oxide, manganese oxide, tungsten oxide, niobium oxide, bismuth oxide, titanium oxide, mixed tin-zinc oxide, and zirconium oxide. In addition, transition metal oxides (such as scandium oxide, yttrium oxide, tantalum oxide or lanthanide oxides (such as lanthanum oxide or cerium oxide) can also be used. The reflection-enhancing coating preferably contains one or more of these materials or is based thereon.

The reflection-enhancing coating does not have to be particularly thick to perform its function. In terms of the optical properties, in particular light transmittance, and in terms of production costs, it is advantageous for the reflection-enhancing coating to be as thin as possible. However, to optimize the overall aesthetics of the composite pane, higher layer thicknesses may also be desired. In an advantageous embodiment, the thickness of the reflection-enhancing coating is at most 100 nm, preferably at most 50 nm, particularly preferably at most nm, most particularly preferably at most 10 nm. The minimum thickness of the reflection-enhancing coating is preferably 5 nm.

In principle, such a reflection-enhancing coating can be applied by physical or chemical vapor deposition, i.e., can be a PVD or CVD coating (PVD: physical vapor deposition, CVD: chemical vapor deposition). Such coatings can be produced with particularly high optical quality and with particularly low thickness. The thickness of the PVD or CVD coating is, for example, at most 30 nm or at most 15 nm or at most 10 nm. Suitable materials are in particular silicon nitride, a mixed silicon-metal nitride (for example, silicon-zirconium nitride, mixed silicon-aluminum nitride, mixed silicon-hafnium nitride, or mixed silicon-titanium nitride), aluminum nitride, tin oxide, manganese oxide, tungsten oxide, niobium oxide, bismuth oxide, titanium oxide, zirconium oxide, zirconium nitride, or mixed tin-zinc oxide. A PVD coating can be a coating applied by cathodic sputtering (“sputtered”), in particular a coating applied by magnetron-enhanced cathodic sputtering (“magnetron sputtered”).

According to the invention, the reflection-enhancing coating is, on the other hand, a sol-gel coating. Advantages of the sol-gel method as a wet chemical method are high flexibility, which allows, for example, in a simple manner, providing only parts of the pane surface with the coating, and low costs compared to other vapor deposition methods such as cathodic sputtering. However, sol-gel coatings typically cannot be applied quite as thinly as sputtered coatings. The thickness of the sol-gel coating is preferably at most 100 nm, particularly preferably at most 50 nm, most particularly preferably at most 30 nm. The sol-gel coating preferably contains titanium oxide or zirconium oxide, in order to achieve the refractive index according to the invention.

In the sol-gel method, first, a sol containing the precursors of the coating is provided and ripened. The ripening can involve hydrolysis of the precursors and/or a (partial) reaction between the precursors. The precursors are usually present in a solvent, preferably water, alcohol (in particular, ethanol), or a water-alcohol mixture.

In one embodiment, the sol-gel coating is based on titanium oxide or zirconium oxide. In this case, the sol contains titanium oxide or zirconium oxide precursors.

In another embodiment, the sol-gel coating is based on silicon oxide with refractive-index-enhancing additives. In this case, the sol preferably contains silicon oxide precursors in a solvent. The precursors are preferably silanes, in particular tetraethoxysilanes or methyltriethoxysilane (MTEOS). Alternatively, however, silicates can also be used as precursors, in particular sodium, lithium, or potassium silicates, for example, tetramethyl orthosilicate, tetraethyl orthosilicate (TEOS), tetraisopropyl orthosilicate, or organosilanes of the general form R²ₙSi(OR¹)₄₋ₙ. Here, R¹ is preferably an alkyl group; R² is an alkyl, epoxy, acrylate, methacrylate, amine, phenyl, or vinyl group; and n is an integer from 0 to 2. Silicon halides or alkoxides can also be used. The silicon oxide precursors result in a sol-gel coating of silicon oxide. In order to increase the refractive index of the coating to the value according to the invention, refractive-index-enhancing additives, preferably titanium oxide and/or zirconium oxide, or their precursors, are added to the sol. In the finished coating, the refractive-index-enhancing additives are present in a silicon oxide matrix. The molar ratio of silicon oxide to refractive-index-enhancing additives can be selected freely as a function of the desired refractive index and is, for example, around 1:1.

The sol is applied to the interior-side surface of the inner pane, in particular by wet chemical methods, for example, by dip coating, spin coating, flow coating, by application using rollers or brushes, or by spray coating, or by printing methods, for example, by pad printing, or screen printing. This can be followed by drying, wherein solvent is evaporated. This drying can be carried out at ambient temperature or by separate heating (for example, at a temperature of up to 120° C.). Before application of the coating to the substrate, the surface is typically cleaned by methods known per se.

Subsequently, the sol is condensed. The condensation can include a temperature treatment that can be carried out as a separate temperature treatment at, for example, up to 500° C., or as part of a glass bending process, typically at temperatures of 600° C. to 700° C. If the precursors have UV-cross-linkable functional groups (for example, methacrylate, vinyl, or acrylate groups), the condensation can include a UV treatment. Alternatively, for suitable precursors (for example, silicates), the condensation can include an IR treatment. Optionally, solvent can be evaporated, for example, at a temperature of up to 120° C.

If desired, the porosity can be adjusted by adding suitable pore formers to the sol. In particular, the porosity can be used to selectively adjust the refractive index. Polymer nanoparticles can be used, for example, as pore formers, preferably PMMA nanoparticles (polymethyl methacrylate), but, alternatively, also nanoparticles of polycarbonates, polyesters, or polystyrenes, or copolymers of methyl (meth)acrylates and (meth)acrylic acid. Instead of polymer nanoparticles, nanodroplets of an oil can be used in the form of a nano-emulsion, or surfactants or core-shell particles can be used. Of course, it is also conceivable to use different pore formers. The pore formers can optionally be removed after condensation of the sol, for example, by a heat treatment resulting in decomposition of the pore former, or by dissolving them out with a solvent. Organic pore formers in particular are carbonized during a heat treatment. Porosity can also be created by depositing sol-gel nanoparticles.

In the context of the invention, if a first layer is arranged “above” a second layer, this means that the first layer is arranged farther from the substrate on which the coating is applied than the second layer. In the context of the invention, if a first layer is arranged “below” a second layer, this means that the second layer is arranged farther from the substrate than the first layer.

When a layer is based on a material, the layer consists for the most part of this material, in particular substantially of this material in addition to any impurities or dopants. The oxides and nitrides mentioned can be deposited stoichiometrically, substoichiometrically, or superstoichiometrically (even though a stoichiometric molecular formula is reported, for better understanding). They can have dopants, for example, aluminum, zirconium, titanium, or boron.

In order to achieve the advantageous effect on the HUD projection, the reflection-enhancing coating must be arranged at least in the HUD region on the interior-side surface of the inner pane. The coating can also be arranged over the entire surface on the entire interior-side surface. In an advantageous embodiment, the reflection-enhancing coating is not applied over the entire surface on the entire interior-side surface, but, instead, only on a subregion of the interior-side surface, corresponding, for example, to at most 5% of the entire surface, preferably at most 50%. This subregion contains the entire HUD region, and can, optionally, include other regions adjacent the HUD region. Thus, for example, only a lower subregion of the composite pane adjacent the lower edge, in particular the lower half of the composite pane, can be fully or partially provided with the reflection-enhancing coating. On the one hand, by not completely arranging the reflection-enhancing coating over the entire surface, material can be saved. On the other hand, other functional regions of the composite pane, for example, a camera or sensor region which is typically arranged near the upper edge, can remain free of the coating and thus not be adversely affected.

A non-full-surface coating can be obtained in the case of vapor deposition (for example, cathodic sputtering) by masking methods or by subsequent partial removal of the coating (for example, by laser irradiation or mechanically abrasively). In the case of the sol-gel coating according to the invention the non-full-surface coating is even easier to achieve in that the sol is applied only on the desired region, for example, by pad printing, screen printing, partial application using rollers or brushes or by spray coating, or also by masking techniques.

The refractive index of the reflection-enhancing coating can have a gradient. In this case, the refractive index preferably decreases in the direction from the lower edge to the upper edge of the composite pane (“from bottom to top”). This advantageously makes it possible to adapt the refractive index locally to the angle of incidence of the HUD radiation, which typically also decreases from the bottom to the top. Such a gradient of the refractive index can be generated, for example, in the sol-gel method according to the invention. The sol can, for example, be provided with a gradient of the precursor concentration by means of decantation and be applied accordingly on the pane surface. Alternatively, for example, two or more sols with different precursor concentrations can be applied adjacent to and in contact with one another, with a concentration gradient being formed by diffusion across the interface before the sol is condensed. Alternatively, methods to form gradients based on so-called “self-stratifying” systems are known.

The reflection-enhancing coating can also have a gradient in terms of its thickness. For example, the thickness of the reflection-enhancing coating can increase in a direction from the lower edge to the upper edge (“from bottom to top”) or vice versa (“from top to bottom”). A thickness gradient can, for example, be created by means of the sol-gel method according to the invention, wherein the sol is printed onto the pane surface by screen-printing through an appropriately designed mesh. A thickness gradient can also be achieved by cathodic sputtering with suitable masks.

The arrangement of the reflection-enhancing coating on the interior-side surface according to the invention brings about a significant weakening of the undesirable ghost image. In principle, a certain reflection of the projector radiation also occurs on the exterior-side surface, likewise resulting in a ghost image. However, since the intensity of the radiation is already reduced by the reflection at the reflection coating before this reflection, this ghost image appears less strongly and the reflection at the exterior-side surface of the outer pane is less critical. In order to further reduce the relative intensity of this ghost image compared to the primary image, in a particularly advantageous embodiment of the invention, the composite pane is equipped with another reflection-enhancing coating (high-refractive-index coating) on the exterior-side surface of the outer pane facing away from the intermediate layer. The composite pane then has two reflection-enhancing coatings, whose specific design can be selected independently of one another. The further reflection-enhancing coating can also be a sol-gel coating or a PVD or CVD coating.

The reflection of the projector radiation occurs primarily from the reflection coating. The residual reflections emanating from the external pane surfaces are further reduced by reflection-enhancing coating. Consequently, it is not necessary to arrange the external pane surfaces at an angle relative to one another in order to avoid ghost images. The external surfaces of the composite pane (i.e., the interior-side surface of the inner pane and the exterior-side surface of the outer pane) are, consequently, preferably arranged substantially parallel to one another. For this purpose, the thermoplastic intermediate layer is preferably not implemented wedge-like, but, instead, has a substantially constant thickness, in particular even in the vertical course between the upper edge and the lower edge of the composite pane, just like the inner pane and the outer pane. A wedge-like intermediate layer would, in contrast, have a variable thickness, in particular an increasing thickness. The intermediate layer is typically formed from at least one thermoplastic film. Since standard films are significantly more economical than wedge films, the production of the composite pane is significantly more economical.

The outer pane and the inner pane are preferably made of glass, in particular of soda lime glass, which is customary for window panes. In principle, however, the panes can also be made of other types of glass (for example, borosilicate glass, quartz glass, aluminosilicate glass) or transparent plastics (for example, polymethyl methacrylate or polycarbonate). The thickness of the outer pane and the inner pane can vary widely. Preferably used are panes with a thickness in the range from 0.8 mm to 5 mm, preferably from 1.4 mm to 2.5 mm, for example, those with the standard thicknesses of 1.6 mm or 2.1 mm.

The outer pane, the inner pane, and the thermoplastic intermediate layer can be clear and colorless, but also tinted or colored. In a preferred embodiment, the total transmittance through the windshield (including the reflection coating) is greater than 70% (illuminant type A). The term “total transmittance” is based on the process for testing the light permeability of motor vehicle windows specified by ECE-R 43, Annex 3, § 9.1. The outer pane and the inner panes can, independently of one another, be non-prestressed, partially prestressed, or prestressed. If at least one of the panes is to be prestressed, this can be thermal or chemical prestressing.

The composite pane is preferably curved in one or a plurality of spatial directions, as is customary for motor vehicle window panes, wherein typical radii of curvature are in the range from approx. 10 cm to approx. 40 m. The composite pane can, however, also be flat, for example, when it is intended as a pane for buses, trains, or tractors.

The thermoplastic intermediate layer contains at least one thermoplastic polymer, preferably ethylene vinyl acetate (EVA), polyvinyl butyral (PVB), or polyurethane (PU) or mixtures or copolymers or derivatives thereof, particularly preferably PVB. The intermediate layer is typically formed from a thermoplastic film (bonding film). The thickness of the intermediate layer is preferably from 0.2 mm to 2 mm, particularly preferably from 0.3 mm to 1 mm.

The composite pane is can [sic] be produced by methods known per se. The outer pane and the inner pane are laminated together via the intermediate layer, for example, by autoclave methods, vacuum bag methods, vacuum ring methods, calender methods, vacuum laminators, or combinations thereof. The bonding of the outer pane and the inner pane is customarily done under the action of heat, vacuum, and/or pressure.

If the reflection layer is implemented as a reflection coating, the reflection coating is preferably applied to one pane surface by physical vapor deposition (PVD) before lamination, particularly preferably by cathodic sputtering (sputtering), most particularly preferably by magnetron-enhanced cathodic sputtering (magnetron sputtering). Instead of applying the reflection coating on one pane surface, it can, in principle, also be provided on a carrier film that is arranged in the intermediate layer, in particular between two bonding films. Customary carrier films are made, for example, of polyethylene terephthalate (PET) and have a thickness of 10 μm to 100 μm, for example, 50 μm.

The reflection-enhancing coating is, as already described above, applied to the interior-side surface of the inner pane using a sol-gel method. This can be done before or after lamination. Preferably, the application of the reflection-enhancing coating is done before lamination and any bending processes since coatings can be applied more easily and with better quality on flat substrates. However, pad printing processes in particular can also be used on curved panes without difficulty.

If the composite pane is to be bent, the outer pane and the inner pane are subjected to a bending process, preferably before lamination and preferably after any coating processes. Preferably, the outer pane and the inner pane are bent congruently together (i.e., at the same time and by the same tool), since, thus, the shape of the panes is optimally matched for the subsequently occurring lamination. Typical temperatures for glass bending processes are, for example, 500° ° C. to 700° C. This temperature treatment also increases the transparency and reduces the sheet resistance of the reflection coating.

For producing the projection assembly according to the invention, the composite pane and the HUD projector are arranged relative to each other such that the inner pane faces the projector and the projector is directed at the HUD region.

The invention further includes the use of a projection assembly according to the invention as an HUD in a motor vehicle, in particular in a passenger car or a truck.

In the following, the invention is explained in detail with reference to drawings and exemplary embodiments. The drawings are schematic representations and are not true to scale. The drawings in no way restrict the invention.

They depict:

FIG. 1 a plan view of a composite pane of a generic projection assembly,

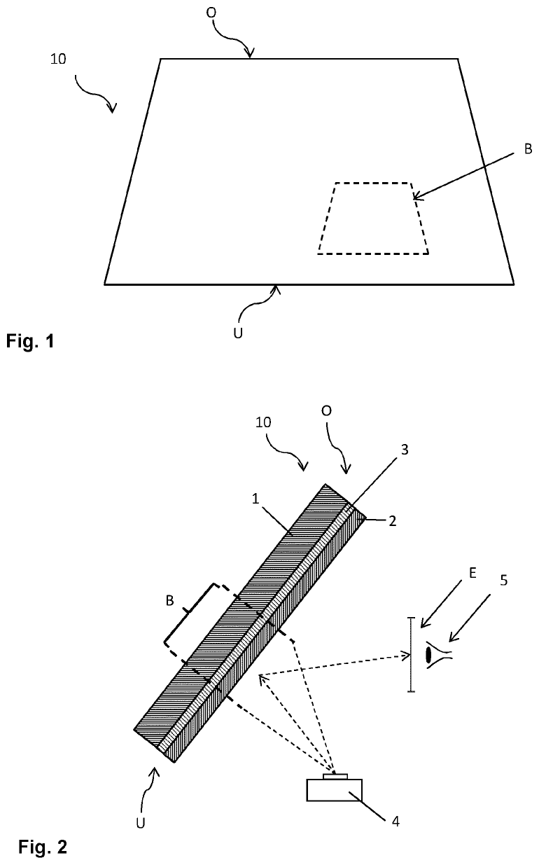

FIG. 2 a cross-section through a generic projection assembly,

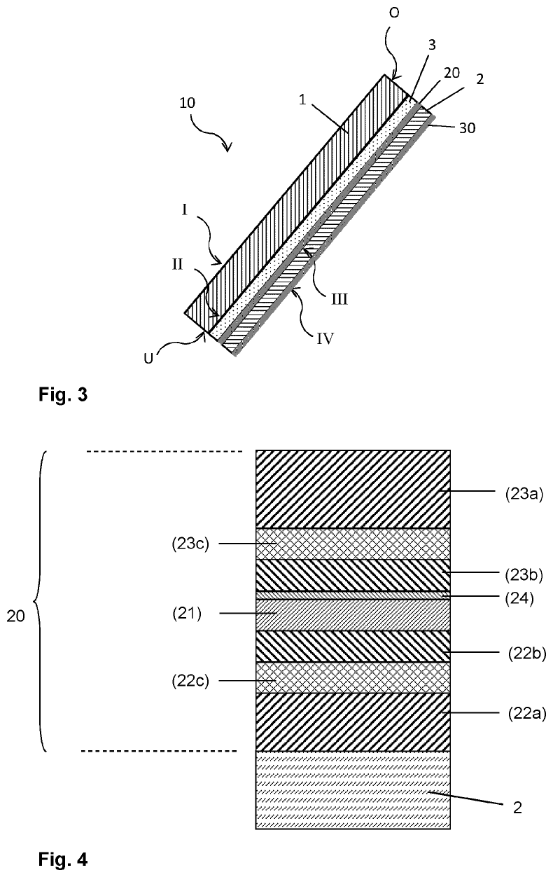

FIG. 3 a cross-section through a composite pane of a projection assembly according to the invention,

FIG. 4 a cross-section through an embodiment of the reflection coating according to the invention on an inner pane (not claimed as such), and

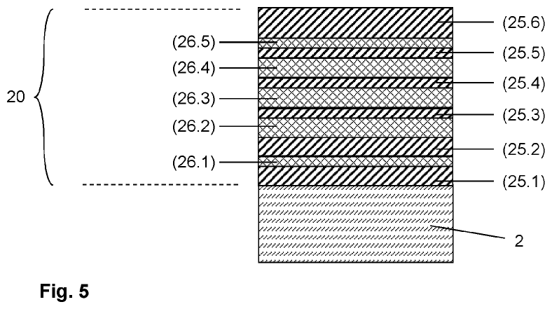

FIG. 5 a cross-section through another embodiment of the reflection coating according to the invention on an inner pane (not claimed as such).

FIG. 1 and FIG. 2 depict in each case a detail of a generic projection assembly for an HUD. The projection assembly comprises a composite pane 10, in particular the windshield of a passenger car. The projection assembly also comprises an HUD projector 4 that is directed at a region of the composite pane 10. The radiation of the projector 4 is fully p-polarized. In this region, usually referred to as HUD region B, the projector 4 can generate images that are perceived by a viewer 5 (vehicle driver) as virtual images on the side of the composite pane facing away from him when his eyes are situated within the so-called eye box E.

The composite pane 10 is constructed from an outer pane 1 and an inner pane 2 that are joined to one another via a thermoplastic intermediate layer 3. Its lower edge U is arranged downward in the direction of the engine of the passenger car; its upper edge O upward in the direction of the roof. In the installed position, the outer pane 1 faces the outside environment; the inner pane 2, the vehicle interior.

FIG. 3 depicts an embodiment of a composite pane 10 implemented according to the invention. The outer pane 1 has an exterior-side surface I that faces the outside environment in the installed position and an interior-side surface II that faces the interior in the installed position. Likewise, the inner pane 2 has an exterior-side surface III that faces the outside environment in the installed position and an interior-side surface IV that faces the interior in the installed position. The outer pane 1 and the inner pane 2 are made, for example, of soda lime glass. The outer pane 1 has, for example, a thickness of 2.1 mm; the inner pane 2, a thickness of 1.6 mm or 2.1 mm. The intermediate layer 3 is made, for example, of a PVB film with a thickness of 0.76 mm. The PVB film has a substantially constant thickness, apart from any surface roughness common in the art—it is not implemented as a so-called “wedge film”.

The exterior-side surface III of the inner pane 2 is provided with a reflection layer according to the invention, which is intended as a reflection surface for the p-polarized projector radiation. In the case depicted, the reflection layer is implemented as a reflection coating 20.

The reflection coating 20 is optimized to reflect p-polarized radiation. It serves as a reflection surface for the radiation of the projector 4 to generate the HUD projection. However, since the angle of incidence of the projector radiation deviates slightly from Brewster's angle, some reflection of the projector radiation also occurs at the air/glass transitions, which can result in the formation of low-intensity, but still potentially distracting ghost images. In particular, the reflection from the interior-side surface IV of the inner pane 2 can be critical here because the intensity of the reflected radiation (in contrast to reflection from the exterior-side surface I of the outer pane 1) is not already attenuated by passing through the reflection coating 20. An object of the present invention is to reduce this ghost image.

Whereas it would be intuitively obvious to decrease the reflection from the interior-side surface IV by means of a reflection-reducing coating (anti-reflection coating), the interior-side surface IV of the inner pane 2 is, quite to the contrary, provided, according to the invention, with a reflection-enhancing (highly refractive) coating 30, which increases its overall reflectivity. The reflection-enhancing coating 30 has a refractive index of at least 1.7. Despite the increased overall reflectivity of the interior-side surface IV, the reflection-enhancing coating 30 results in the fact that the reflection quotient R₂₀/R_{IV} derived from the reflectance R₂₀ of the reflection coating 20 divided by the reflectance R_{IV} of the surface IV provided with the reflection-enhancing coating 30 is increased (reflectances in each case with respect to p-polarized radiation). The relative intensity (the “contrast”) of the reflection from the reflection coating 20 relative to the reflection from the interior-side surface IV is increased and the intensity of the desired primary image relative to the undesired ghost image is increased.

FIG. 4 depicts the layer sequence of an exemplary embodiment of the reflection coating 20. The reflection coating 20 is stack of thin films. The reflection coating 20 includes an electrically conductive layer 21 based on silver. A metallic blocking layer 24 is arranged directly above the electrically conductive layer 21. Arranged above that is an upper dielectric layer sequence consisting of, from bottom to top, an upper matching layer 23b, an upper refractive-index-enhancing layer 23c, and an upper anti-reflection layer 23a. Arranged below the electrically conductive layer 21 is a lower dielectric layer sequence, consisting of, from top to bottom, a lower matching layer 22b, a lower refractive-index-enhancing layer 22c, and a lower anti-reflection layer 22a.

Table 1 shows the layer sequences of a composite pane 10 with the reflection coating 20 on the exterior-side surface III of the inner pane 2, together with the materials and geometric layer thicknesses of the individual layers. The dielectric layers can be doped independently of one another, for example, with boron or aluminum.

TABLE 1

| Material | Reference Character | | Layer Thickness | |
|---|---|---|---|---|
| Soda lime glass | 1 | | 2.1 | mm |
| PVB | 3 | | 0.76 | mm |
| Si₃N₄ | 20 | 23a | 50 | nm |
| SiZrN | | 23c | 10 | nm |
| ZnO | | 23b | 10 | nm |
| NiCr | | 24 | 0.3 | nm |
| Ag | | 21 | 13 | nm |
| ZnO | | 22b | 10 | nm |
| SiZrN | | 22c | 10 | nm |
| Si₃N₄ | | 22a | 17 | nm |

| | | | |
|---|---|---|---|
| Soda lime glass | 2 | 2.1 | mm |

### EXAMPLES

The reflection quotient R₂₀/R_{IV} was determined for a composite pane in accordance with Table 1, which provides a measure of how intense the desired HUD reflection from the reflection coating 20 appears compared to the undesired reflection from the interior-side surface IV. In the
Example according to the invention, the composite pane had a reflection-enhancing coating 30 according to the invention on the interior-side surface IV, which was implemented as a single layer based on titanium oxide (refractive index 2.4) with a layer thickness of 70 nm, which was applied using a sol-gel method;
Comparative Example 1, the composite pane had no coating on the interior-side surface IV;
Comparative Example 2, the composite pane had an anti-reflection coating on the interior-side surface IV, which was implemented as a nanoporous SiO₂-layer (refractive index 1.3) with a thickness of 100 nm, which was applied in a sol-gel method;
Comparative Example 3, the composite pane had a high-refractive-index coating 30 on the interior-side surface IV, which was implemented as a single layer based on aluminum-doped silicon nitride (refractive index 2.0) with a layer thickness of 10 nm, which was applied using magnetron-enhanced cathodic deposition.

The reflectances R₂₀ and R_{IV} with respect to p-polarized radiation and the reflection quotient R₂₀/R_{IV} derived therefrom for the Example and the Comparative Examples are summarized in Table 2 for various angles of incidence α. The values were simulated using the common software CODE.

TABLE 2

| | | | Comp. | Comp. | Comp. |
|---|---|---|---|---|---|
| α | | Example | Example 1 | Example 2 | Example 3 |
| 59° | R₂₀ | 18.4% | 18.8% | | 18.8% |
| | R_{IV} | 4.6% | 0.24% | | 0.11% |
| | R₂₀/R_{IV} | 4:1 | 78:1 | | 175:1 |
| 62° | R₂₀ | 19.0% | 19.4% | 19.9% | 19.4% |
| | R_{IV} | 2.8% | 0.6% | 2.5% | 0.02% |
| | R₂₀/R_{IV} | 6.8:1 | 32.3:1 | 8:1 | 970:1 |
| 65° | R₂₀ | 20.2% | 20.5% | 21.1% | 20.5% |
| | R_{IV} | 1.4% | 1.4% | 5.0% | 0.003% |
| | R₂₀/R_{IV} | 14.4:1 | 14.6:1 | 4.2:1 | 6833:1 |
| 68° | R₂₀ | 22.2% | 22.4% | 23.0% | 22.4% |
| | R_{IV} | 0.36% | 2.8% | 9.0% | 0.1% |
| | R₂₀/R_{IV} | 62:1 | 8:1 | 2.5:1 | 224:1 |
| 71° | R₂₀ | 25.1% | 25.4% | | 25.3% |
| | R_{IV} | 0.13% | 5.2% | | 0.32% |
| | R₂₀/R_{IV} | 193:1 | 4.9:1 | | 78:1 |

It can be seen from Table 2 that at large angles of incidence α, the reflection-enhancing coating 30 according to the invention results in a significant increase in the reflection quotient R₂₀/R_{IV} compared to an uncoated pane (Comparative Example 1). As a result, the HUD reflection from the reflection coating 20 is significantly more perceptible compared to the ghost image. In contrast thereto, a reflection-reducing coating (Comparative Example 2) results, at all angles of incidence ox, in a reduction of the reflection quotients R₂₀/R_{IV}, although one would initially intuitively assume that such a coating would weaken the reflection from the interior-side surface IV and would thus increase the reflection quotient R₂₀/R_{IV}.

Compared to a sputtered-on high-refractive-index coating of silicon nitride (Comparative Example 3), the reflection-enhancing coating 30 according to the invention likewise results, at large angles of incidence α, in an increase in the reflection quotient R₂₀/R_{IV}. The Example according to the invention is thus particularly suitable for the case of very shallow installation angles of the windshield, which result in greater angles of incidence α. The reason for the observation is the higher refractive index in the Example (titanium oxide: 2.4) compared to the Comparative Example 3 (silicon nitride: 2.0). Also, with sol-gel coatings, optimization of the reflection quotient for smaller angles of incidence can be achieved through suitable selection of materials. In particular, it is possible to selectively adjust the refractive index to the requirements in the specific application, for example, by using a sol-gel coating based on SiO₂ with refractive-index-enhancing additives such as TiO₂ or ZrO₂, wherein it is possible to regulate the refractive index by the proportion of refractive-index-enhancing additives.

Table 3 summarizes color values for the Example according to the invention and the Comparative Examples. These are indicated as color values a* and b*in the L*a*b*-color space, measured under irradiation with a D65 light source. The angle specification describes the observation angle (angle at which the light beam strikes the retina). In contrast to the Comparative Examples, only negative color values are observed in the Example. This corresponds to a less conspicuous color scheme that is better accepted by the car manufacturer and the end customer.

TABLE 3

| | | Comp. | Comp. | Comp. |
|---|---|---|---|---|
| | Example | Example 1 | Example 2 | Example 3 |
| a* 8° | −2.0 | +0.6 | +1.2 | +0.4 |
| b* 8° | −4.4 | −4.7 | −5.4 | −5.1 |
| a* 60° | −1.5 | +0.4 | +1.1 | +0.3 |
| b* 60 | −2.3 | −1.5 | −1.0 | −1.9 |

FIG. 5 depicts the layer sequence of another embodiment of the reflection coating 20. In this case, the reflection coating 20 has no metallic layer, but is, instead, composed purely of dielectric layers. The reflection coating 20 is a stack of thin films, with a total of six dielectric, optically high-refractive-index layers 25 (25.1, 25.2, 25.3, 25.4, 25.5, 25.6) and five dielectric, optically low-refractive-index layers 26 (26.1, 26.2, 26.3, 26.4, 26.5) deposited alternatingly on an inner pane 2. The optically high-refractive-index layers 25.1, 25.2, 25.3, 25.4, 25.5, 25.6 are based on silicon nitride having a refractive index of 2.0. The optically low-refractive-index layers 26.1, 26.2, 26.3, 26.4, 26.5 are based on silicon oxide having a refractive index of 1.5.

The layer sequence can be seen schematically in the figure. The layer sequence of a composite pane 10 with the reflection coating 20 on the exterior-side surface III of the inner pane 2 is also presented, together with the materials and layer thicknesses of the individual layers, in Table 4.

TABLE 4

| Material | Reference Characters | | Layer Thickness | |
|---|---|---|---|---|
| Soda lime glass | 1 | | 2.1 | mm |
| PVB | 3 | | 0.76 | mm |
| Si₃N₄ | 20 | 25.6 | 212.8 | nm |
| SiO₂ | | 26.5 | 61.8 | nm |
| Si₃N₄ | | 25.5 | 41.7 | nm |
| SiO₂ | | 26.4 | 108.8 | nm |
| Si₃N₄ | | 25.4 | 69.7 | nm |
| SiO₂ | | 26.3 | 113.2 | nm |
| Si₃N₄ | | 25.3 | 68.6 | nm |
| SiO₂ | | 26.2 | 107.4 | nm |
| Si₃N₄ | | 25.2 | 127.4 | nm |
| SiO₂ | | 26.1 | 51.3 | nm |
| Si₃N₄ | | 25.1 | 93.1 | nm |

| | | | |
|---|---|---|---|
| Soda lime glass | 2 | 1.6 | mm |

### LIST OF REFERENCE CHARACTERS

(10) composite pane
(1) outer pane
(2) inner pane
(3) thermoplastic intermediate layer
(4) HUD projector
(5) viewer/vehicle driver
(20) HUD reflection coating
(21) electrically conductive layer
(22a) first lower dielectric layer/anti-reflection layer
(22b) second lower dielectric layer/matching layer
(22c) third lower dielectric layer/refractive-index-enhancing layer
(23a) first upper dielectric layer/anti-reflection layer
(23b) second upper dielectric layer/matching layer
(23c) third upper dielectric layer/refractive-index-enhancing layer
(24) metallic blocking layer
(25) optically high-refractive-index layer
(25.1), (25.2), (25.3), (25.4), (25.5), (25.6) 1., 2., 3., 4., 5., 6. optically high-refractive-index layer
(26) optically low-refractive-index layer
(26.1), (26.2), (26.3), (26.4), (26.5) 1., 2., 3., 4., 5. optically low-refractive-index layer
(30) high-refractive-index coating/reflection-enhancing coating
(O) upper edge of the windshield 10
(U) lower edge of the windshield 10
(B) HUD region of the windshield 10
(E) eye box
(I) exterior-side surface of the outer pane 1
(II) interior-side surface of the outer pane 1
(III) exterior-side surface of the inner pane 2
(IV) interior-side surface of the inner pane 2

1. Projection A projection assembly for a head-up display, comprising:
a composite pane, comprising an outer pane and an inner pane that are joined to one another via a thermoplastic intermediate layer, the composite pane having an HUD region;
an HUD reflection layer suitable for reflecting p-polarized radiation, on a surface of the outer pane or of the inner pane facing the thermoplastic intermediate layer or within the thermoplastic intermediate layer;
an HUD projector that is directed at the HUD region and that is adapted to emit p-polarized radiation, and
a high-refractive-index coating having a refractive index of at least 1.7 on a surface of the inner pane facing away from the thermoplastic intermediate layer,
wherein the high-refractive-index coating is a sol-gel coating.

2. The projection assembly according to claim 1, wherein the radiation of the HUD projector strikes the composite pane with an angle of incidence of 58° to 72°.

3. The projection assembly according to claim 1, wherein the refractive index of the high-refractive-index coating is at least 1.8.

4. The projection assembly according to claim 1, wherein the high-refractive-index coating contains silicon nitride, a mixed silicon-metal nitride, aluminum nitride, tin oxide, manganese oxide, tungsten oxide, niobium oxide, bismuth oxide, titanium oxide, mixed tin-zinc oxide, zirconium oxide, scandium oxide, yttrium oxide, tantalum oxide, lanthanum oxide, or cerium oxide.

5. The projection assembly according to claim 1, wherein a thickness of the high-refractive-index coating is at most 100 nm.

6. The projection assembly according to claim 1, wherein the high-refractive-index coating contains titanium oxide or zirconium oxide.

7. The projection assembly according to claim 1, wherein a reflection quotient R₂₀/R_{IV} is at least 50:1, wherein R₂₀ is the reflectance of the HUD reflection layer and R_{IV} is the reflectance of the surface provided with the high-refractive-index coating, in each case with respect to p-polarized radiation.

8. The projection assembly according to claim 1, wherein the high-refractive-index coating is not applied over the entire surface of the inner pane, but at least on a region of the surface that contains the HUD region.

9. The projection assembly according to claim 1, wherein the refractive index of the high-refractive-index coating has a gradient, wherein the refractive index decreases in a direction from a lower edge to an upper edge of the composite pane.

10. The projection assembly according to claim 1, wherein the HUD reflection layer is an HUD reflection coating that is implemented as a thin-film stack that includes at least one electrically conductive layer.

11. The projection assembly according to claim 1, wherein the HUD reflection layer is an HUD reflection coating that is implemented as a thin-film stack that contains only dielectric layers.

12. The projection assembly according to claim 1, wherein the HUD reflection layer is a polymer film that includes a plurality of polymeric plies, wherein plies with a higher and a lower refractive index are arranged alternatingly.

13. The projection assembly according to claim 1, wherein the composite pane is equipped with a further high-refractive-index coating on the surface of the outer pane facing away from the thermoplastic intermediate layer.

14. The projection assembly according to claim 1, wherein the outer pane and the inner pane are made of soda lime glass.

15. The projection assembly according to claim 1, wherein the composite pane is a windshield of a passenger car.

16. The projection assembly according to claim 2, wherein the angle of incidence is from 62° to 68°.

17. The projection assembly according to claim 3, wherein the refractive index of the high-refractive-index coating is at least 2.0.

18. The projection assembly according to claim 5, wherein the thickness of the high-refractive-index coating is at most 50 nm.

19. The projection assembly according to claim 18, wherein the thickness of the high-refractive-index coating is at most 10 nm.

20. The projection assembly according to claim 10, wherein the at least one electrically conductive layer is based on silver.
